(19) United States
(12) Patent Application Publication
(10) Pub. No.: US 2024/0007276 A1
(43) Pub. Date: Jan. 4, 2024

(54) METHOD OF MIGRATING AN IT APPLICATKION

(71) Applicant: FACHHOCHSCHULE ST. POLTEN GMBH, Osterreich (AT)

(72) Inventor: Ernst PILLER, Vienna (AU)

(21) Appl. No.: 18/265,102

(22) PCT Filed: Dec. 7, 2021
(86) PCT No.: PCT/AT2021/060465

§ 371 Date: Jun. 2, 2023

(30) Foreign Application Priority Data
Jul. 12, 2020 (AU) A51063/2020

(51) Int. Cl. H04L 9/08; H04L 9/06; H04L 9/00

(52) U.S. Cl. CPC H04L 9/0852; H04L 9/50; H04L 9/0631

(57) ABSTRACT

So that a method of migrating an IT-application running on a central system to an IT-application (1) using blockchain technology or Distributed Ledger Technology (DLT) that runs on several nodes (3), including all or certain data, so that the entire processing of the IT-application (1) takes place in the nodes (3) including all relevant data, and for a secure traceability of the processing the data required for this are concatenated by a concatenation (11) and the nodes (3) exchange the required data via a network (13), can be carried out as simply and largely automatically as possible, it is provided in accordance with the invention that a program is integrated in the operating-system (4) and/or before and/or in and/or after database-system(s) (5) and/or IT-applications (1) as middleware (6), so that the IT-application (1) is not application (1) does not have to be modified or only slightly modified, and that, in accordance with the authorizations and thus the relevant read protection, the data blocks (7) or parts thereof are cryptographically encrypted (9) before writing and the data blocks (7) or parts thereof are cryptographically decrypted (10) after reading.

### FIELD OF THE INVENTION

The present invention relates to a method according to the preamble of claim 1.

### BACKGROUND OF THE INVENTION

There are three processing modes to choose from: in the first, there is no concatenation of data, in the second, the data is concatenated in a multi-stage concatenation system, and in the third, only the hash values of the data including data headers are concatenated.

Distributed Ledger Technology (DLT) is the umbrella term for blockchain technologies and various types of direct acyclic graphs (DAG) technologies. In the following, the term blockchain is always used, but concatenation and the ideas of DAGs are also possible. That is, in the patent procedure, no distinction is made between blockchain and DLT. Today, blockchains are backed by implementations such as Bitcoin, Ethereum, etc., so-called blockDAGs are backed by implementations such as Nano or RChain, and TDAGs are backed by implementations such as IOTA or Byteball.

Distributed ledger technology, or better known as blockchain technology, is a technological trend that has the potential to transform quite a few areas of society and large industries such as finance, logistics, healthcare, public sector applications, etc. In blockchains, all processing and storage of data is done on-site in so-called “nodes” and the data is permanently and immutably chained using a cryptographic method.

By moving away from centralized systems, long-term cryptographic chaining of all data, and local processing and storage of data, blockchains often increase trust in the application, IT availability, non-repudiation, and traceability of all processing.

Today's blockchain technologies form an independent, closed “IT world” for which new suitable IT applications are being sought and realized. This is giving rise to entirely new blockchain solutions that fit very well.

Current IT with IT processing in central IT-systems (host-systems) has different goals, a different orientation than today's blockchain technologies. There are considerable differences between the use of blockchain technologies in their environment and the centralized, classic IT world. As a result, the many millions of IT-applications already successfully in use today and processed in centralized IT-systems are not a direct candidate for blockchain technologies. The reasons for this lie primarily in the interfaces and authorization systems, logical access protection (especially read protection), IT security, the deletion option (important for GDPR—general data protection regulations) and memory release.

### SUMMARY OF THE INVENTION

It is the object of the present invention to create a method with which millions of already existing IT applications from our central, classical IT rooted in everyday business can be extended in a simple manner in such a way that the definition and the goals of blockchains are fulfilled. In doing so, it should be possible to continue using the existing central IT-systems.

This object is attained by a method according to the preamble of claim 1 according to the invention in that a program is integrated into the operating system and/or before and/or in and/or after database system(s) and/or IT applications as middleware, so that the IT application does not have to be changed or only slightly changed, and in that, in accordance with the authorizations and thus the relevant read/write protection, the data or parts thereof are cryptographically encrypted before being written to a nonvolatile data memory and/or database system and/or file system and, after being read from a nonvolatile data memory and/or database system and/or file system, the data or parts thereof are crypto-graphically decrypted.

In addition to the usually central authorization and authorization systems already in place, the overall system primarily contains workstations (PCs, laptops, smart phones, etc.) in the form of full nodes that receive all data, light nodes that receive only the desired data, and service nodes that also perform administration/security tasks. Full and light nodes are also called user nodes. Each node can be a user node and/or a service node if required. In addition, the existing central IT-system can be fully maintained for all users who wish to continue working as before.

In the following, we refer to an extension of the IT application into a blockchain or at least into a decentralized system. This extension can often happen completely automatically by the middleware if no changes are required in the IT application. In practice, however, an at least minor porting will usually be required, whereby some adjustments are made.

It is useful if the access authorizations to data in database systems (DBMS) and files are stored in a “management blockchain” and this management blockchain is accessible to all nodes, and this management blockchain is created from the data of the authorization systems present in the central IT-system and/or other data from a management unit in service nodes and in nodes this management unit is connected in the middleware to the applications and/or the operating system and/or the database systems and/or the central authorization systems. The existing authorization systems are thus retained. The data of the authorization systems are only additionally mapped on an management blockchain to fulfill the “blockchain requirements” and this management blockchain is sent to all nodes with each change, so that on the one hand each node knows all current data of the authorization systems at all times, even if a central authorization system fails, and on the other hand so that all changes of authorizations are located unchanged in an management blockchain and therefore all processes can be traced later.

The management blockchain may preferably contain different block types in the form of node blocks, namely:
node blocks with important information about all nodes authorization blocks with all relevant authorizations authorizations determined from one or more conditions certificate blocks with all required certificates and/or
parameter blocks with all required values for key management and/or data encryption/decryption and/or data conversion and/or root-key calculation.

The central authorization and permission systems for delivering current authorizations may be preserved, and the central systems for processing applications for users who wish to continue to work through the central systems may also be preserved while acting as their own nodes. Because data encrypted in the nodes is used unencrypted in the central systems, the data must be suitably decrypted before it is transferred to a central system and suitably encrypted after it leaves the central system. No concatenation of data occurs in central systems. As before, central systems directly process users' applications and store the data. Central IT-systems are also called host systems and are often located in a cloud.

An essential point is data security. With a centralized IT-system, one can easily prevent unauthorized access by having the central IT-system not give out the requested information to unauthorized users. In a blockchain, however, the entire data is present at each full node, and one cannot prevent a savvy user from accessing this data by bypassing the database software (DBMS—data base management system), since he usually has administrator rights on his computer. Since local users on the nodes can thus usually gain sovereignty over all data, i.e. they have all administrative rights, the existing central authorization systems and logical access control systems (especially read and write protection) can no longer guarantee the necessary protection of the data, since they can be bypassed relatively easily. This protection is therefore solved with the help of suitable encryption and decryption of the data, i.e. with the help of a cryptographic access control system (logical access control system based on cryptography). Because only the authorized nodes know the required cryptographic keys, all nodes can read all data, but they can no longer understand it (for this, a suitable decryption is required).

For secure traceability of processing, the data required for this can be concatenated to form a data blockchain. While this ensures traceability of processing, it has the consequence that data can no longer be deleted without destroying the integrity of the data blockchain.

For this reason, according to a further feature of the invention, it is provided that data can be made unreadable by deleting the key in all nodes despite the concatenation of the data blocks. Thus, despite the concatenation of the data blocks, the data can be made unreadable by deleting the associated key in all nodes, if necessary. “Erasure” in the sense of the GDPR (General Data Protection Regulation), which must be possible for personal data, for example, is understood to mean not only the complete destruction of this information, but also making it unreadable, by destroying the key required for decryption. Since it is in the nature of a blockchain that data cannot be deleted without destroying the concatenation, these features create a solution to still comply with the GDPR.

To increase security, it can be provided that for cryptographic encryption and decryption and computation of electronic signatures only quantum computer secure cryptographic algorithms are used, gitter-based and/or code-based and/or hash-based and/or multivariant cryptography and/or cryptography based on supersingular isogenic curves and/or for symmetric encryption the AES algorithm (Advanced Encryption Standard).

According to one embodiment of the invention, when encrypting data for database systems, the rows and/or columns or data fields of rows of tables are cryptographically encrypted according to the authorizations of users and/or roles and/or other subjects.

Because a node can always write or modify all data at itself, the write protection must contain a further protection in addition to the encryption of the data, in that the other nodes only accept a write operation of a node in their data inventory including blockchain after they have positively checked the write authorization of this node. Thus, if an unauthorized node modifies data, this only affects it locally, but not the entire blockchain or databases or files that is/are distributed decentrally among many nodes.

In another embodiment of the invention, multiple data fields of rows of tables of databases and/or entire rows/columns of tables that have the same encryption/decryption key are combined into a single data field. During encryption and decryption, only this combined data field is then used. Within this combined data field, all individual data fields with different data types are converted to a dense format, i.e. without gaps, before encryption and converted back to the original format after decryption. This saves computing time and storage space.

Because the data fields of rows of tables of databases represent certain types of data and lengths (integers, floating-point numbers, dates, strings), it is convenient if the encryption and decryption of the data preserve the format of the data fields and the length. Similarly, specifications, such as a valid date specification, should be satisfied even after encryption so that they are accepted and properly processed in the database system without the need to modify the database system in this regard. For this purpose, in one embodiment of the invention format-preserving-encryption (FPE) is used so that the data type and length are preserved and date specifications remain valid specifications even after encryption. For this purpose, e.g. FF1 or FF3 according to NIST Special Publication 800-38G (Recommendation for Block Cipher Modes of Operation: Methods for Format-Preserving Encryption) can be used.

If a data type does not allow a complete conversion to an interval 0 to 2n−1, as is the case for floating point numbers or the time (a time represented in hours, minutes and seconds can be densely mapped to an interval from 0 to 86,399, but 86,399 does not represent a power of two−1), encryption is performed as often as necessary until the result is within the desired interval. For the data type time (mostly called TIME in database systems) this means that after the conversion there is a 17-bit long number which is encrypted and afterward there can be a result between 0 and 131,071. If the value after encryption is greater than 86,399, encryption must be performed again, and so on, until the interval 0 to 86,399 is met.

Since keys are known to need to be changed repeatedly, according to a further embodiment of the invention, it is provided that in each node, all older calculations of the read key can be calculated from the current cryptographic read key by asymmetric quantum computer-secure decryption, and new key calculation can be calculated in service nodes or hardware tokens as part of the service node by asymmetric quantum computer-secure encryption. In this way, anyone who has the current read key can decrypt all previously encrypted data, but anyone who does not get a newly calculated key cannot read the data encrypted with the new key.

Preferably, the cryptographic concatenation of the data blocks is separated into a multi-level concatenation system, and at the lowest level no concatenation takes place and this is only valid for the node, and further at the middle level a temporary concatenation takes place and this is only valid for the node, and wherein finally at the upper level with validity in the entire system a final concatenation takes place, whereby the lowest and/or middle level and/or upper level can also be omitted, so that thereby during the processing in the node and before the distribution to all other nodes still memory can be released and storage space can be saved. Instead of data, of database commands or files, only the hash values thereof including header data may also be concatenated.

According to a further embodiment of the invention, it is provided that in at least one data field the possible values are divided into classes, preferably with a class width of 2n, and that an encryption or decryption is carried out as often as necessary until, after the encryption or decryption, the value is again in the given class, so that even after the encryption the values of all the individual elements of a class are greater than or less than the values of all the individual elements of a class, so that thereby the conditions < and > and ≤ and ≥ are preserved despite encryption, whereby the bit length of the individual elements of an interval is always oriented to the required bit length of the largest value of the interval.

In this way, it is possible to execute database commands with where conditions (<, >, ≤, ≥) on the encrypted data, because the where conditions <, >, ≤ and ≥ are satisfied after encryption exactly when they were satisfied before. This can save considerable computing time. The encryption or decryption is performed as often as necessary until the specified interval is again met after the encryption or decryption. All values of an interval “a to b” are larger than all encrypted values of an interval “c to d” even after encryption, if a>d applies. Thus, the conditions <, >, ≤ and ≥ are preserved despite encryption. The bit lengths of the values in the two intervals can be different, e.g. the values of the interval “c to d” can be smaller than those of the interval “a to b”. One will always choose the smallest possible value in order to minimize the encryption/decryption operations.

In the migration provided according to the invention, the central authorization systems for delivering the current authorizations can be retained and/or the central systems for processing applications for users can also be retained and thereby act as their own nodes, whereby the data encrypted in the nodes is used unencrypted in the central systems and therefore the data is suitably decrypted before being transferred to a central system and suitably encrypted after leaving the central system.

According to one embodiment of the invention, in order to increase security, it is provided that the middleware includes an IT security system and that this IT security system specifies the security requirements and/or cryptographic procedures of each individual node, checks them in all nodes and reports deviations to the other nodes.

The calculation and storage of the cryptographic keys and/or the encryption and decryption of the data blocks in the nodes can take place either unprotected in the node or in a hardware-protected sandbox in the node or in external hardware tokens, depending on the level of security, whereby, if required, the IT security system always checks the level of security in the node and reports deviations to all other nodes.

To achieve the necessary asynchrony and transaction speed for cryptographic chaining in the data blockchain and or the management blockchain, a direct-acyclic graph can be used.

Symmetric and asymmetric methods can be used for the encryption and decryption of the data. When using symmetric methods, in one embodiment of the invention the cryptographic keys are derived from so-called root keys by cryptographic methods or hash methods, such as the SHA-2 and SHA-3. For the calculation of the root key with initial value “x”, n nodes are selected at the beginning, called main nodes in the following, where each of these n main nodes determines its own root key-part as a random number. For the calculation of a root key, a commutative asymmetric encryption method is used, such as the Diffie-Hellman method (ECDH with elliptic curves or the quantum computer-secure CSIDH method Com-mutative Supersingular Isogeny Dife-Hellman).

The root key is calculated as follows: First, the start value “x” is encrypted in a main node with this encryption method and the own root key-part as key, then the result is sent step by step to all other main nodes and there the current result is encrypted again in the individual main nodes with the respective root key-part until an encryption with the respective own root key-part has taken place in all main nodes. The root key results from the last main node. If this root key is not to be transmitted unencrypted to the other main nodes, this procedure is carried out n times with different order of the main nodes, so that each main node carries out the last encryption once and thus receives the result.

For the encrypted transmission of the root key to another (new) node, this new node also determines its own root key-part as a random number. Subsequently, the start value “x” is encrypted in the new node using this encryption method and its own root key-part as key. The result is then sent step by step to all main nodes, where the current result is encrypted again in the individual main nodes using the respective root key part until all main nodes have been encrypted using their own root key part. Finally, the result is sent to the new node and decrypted there with its own root key-part. This last result now gives the desired root key. The root key is thus calculated from the encryption of the value of “x” with all root key-parts of the n main nodes. This calculation always gives the same result for a given root key. Because the root key-part of a new node is a random number, each new root key calculation always starts with a different root key-part and therefore all intermediate results are always different for each new root key calculation, which is important for security reasons. Likewise, for security reasons, this encryption in the new node and in the main nodes should be protected only in external high-security hardware tokens, and not in the nodes themselves, and all root key-parts should be located exclusively in these high-security hardware tokens, which is the case in one embodiment of the invention. In another embodiment of the invention, the result of the encryption is also electronically signed in the hardware token of each node and the signature is sent to the next node. All hardware tokens of the main nodes or replacement nodes and of the new node then check this signature before their encryption process and only perform the encryption if the result is positive. This guarantees that all encryption for root key computation is done only in hardware tokens.

For each of these n main nodes, substitute nodes are also selected and these receive their root key-part in encrypted form from the main nodes respectively. Therefore, there is at least one substitute node for each main node.

Finally, according to one embodiment of the invention, it is provided that the read database commands and/or file commands are checked with respect to the read authorization of the relevant user or role or other relevant subject, and that the write database commands and/or file commands are checked with respect to the write authorization of the relevant user or role or other relevant subject are checked by the own node and, in the case of data replication to all other nodes, are checked by the other nodes with the aid of the management unit according to the management blockchain and, if valid, are forwarded to the relevant database system or file system.

In this context, it is expedient if, during data replication at the other nodes, the validity start time of the write authorization is also compared with the time stamp, and the plausibility of the time stamp is checked, and the read and write commands are forwarded to the responsible database system or file system only in the positive case.

Finally, it is also possible to provide that when replicating the data from its own node to all other nodes, the data required for replication is additionally provided with an electronic signature by its own node and sent to all other nodes, and all other nodes check the signature after receiving it and reject the data for data replication from the other nodes if the signature is incorrect.

Thus, according to the present invention, there are provided:
1. A new cryptography-based logical access control system in the form of cryptographic encryption and decryption of data, especially for read protection;
2. A special write protection system in conjunction with encryption and optional electronic signature to protect the writing of data—in conjunction with points 1. and 5. replaces the consensus mechanism of blockchains;
3. An appropriate technical IT security management and appropriate IT security technologies that can guarantee sufficient IT security even on decentralized workstations (PCs, laptops, etc.) by, on the one hand, constantly checking security in the nodes and, on the other hand, moving sensitive parts of the process to hardware-protected environments such as hardware tokens, SGX (Software Guard Extensions) and TPM (Trusted Platform Module);
4. A cryptographic data chaining system that, in file and database systems, performs the necessary chaining of all blocks on the one hand, but is very economical with memory on the other hand by being multi-level and, in the case of databases, chaining only the write database commands including data and other important database commands in addition to header data or only the hash value in the case of data and, in the case of files, chaining all the data of the files in addition to header data or only the hash values of the data;
5. A management blockchain, which is expedient, among other things, because of the centralized authorization systems and permanent availability of the system;
6. A synchronization and replication of all databases in all nodes, which delivers the write database commands and commands grouped into transactions in all nodes in the same order to the database system in each node, taking into account all other local database commands, if necessary.

Migration of an IT application of a central system (host system) to a decentralized IT application running on one or more nodes is performed by suitably integrating the method according to the invention as new middleware into the operating systems, database systems and, if required, IT applications used.

In the following, the parts of the method according to the invention are briefly described:

1. Access Control System

In IT systems commonly used today, where the processing of applications and data takes place in central systems (host systems), there are sophisticated authorization systems in the database systems, operating systems and special authorization systems. These authorization systems guarantee the desired access protection to the data, so that only authorized users of the system are granted access.

If today's IT applications are distributed from a central system to many simple nodes, the logical access protection to the data by the operating system, database system and the applications is omitted in the node. On site at the nodes, the owner/user of the node can have complete sovereignty over his system. He can therefore also set the access permissions to the data stored in his system as he wishes at any time. On this basis, it is not possible to implement and guarantee authorizations such as read and write access to data.

The required access protection is therefore replaced by a cryptographic access protection system in the method according to the invention. It must protect the data from unauthorized reading exclusively by data encryption. The cryptographic keys are calculated in so-called service nodes that are special nodes for security and administrative tasks, or hardware tokens in accordance with ISO/IEC-7816 (EAL4+ certified), which are e.g. highly secure smart cards such as those used today in bank cards, passports or SIM cards, and the cryptographic keys are distributed from there to all nodes in a highly secure (if possible quantum computer secure) encrypted form.

2. Write Protection System

Every write operation, i.e., every change or addition to data, is performed by data encryption where possible and permitted. This encryption also allows read protection (see above). However, since each node can overwrite existing data—and in the case of a full node this means all data—at any time, write protection requires an additional protection mechanism. Every write operation at a node, especially in files or databases, must be communicated to every other node via the communication system as part of the data replication process, so that the data is the same in all nodes. This is done by each node providing the data required for replication with a digital/electronic signature during this data replication and sending it to all other nodes. An ECDSA or a method from post-quantum cryptography, for example, can be used as the electronic signature method of this purpose. The nodes that receive the data required for replication, including the signature, verify the electronic signature and thus the integrity and authenticity of the data. If these nodes determine that the sending node had the required write authorization according to the management blockchain, they transfer the received data in an appropriate form to their data pool (file or database) at the correct locations, otherwise the received data block is rejected.

3. Security Management

A sensitive area of blockchains and decentralized systems with simple nodes is IT security. It is much easier to adequately secure and audit the IT security of a central system (host system) than hundreds or thousands of simple nodes. However, if the IT applications and data storage are handled entirely on these nodes, which is the case with blockchains, the overall security depends on each individual node. This means that suitable organizational and technical IT security management and IT security technologies are required that can guarantee sufficient IT security even on decentralized workstations/user nodes. For example, it is determined here whether the data is encrypted symmetrically or asymmetrically, which cryptographic procedure and key management is used, where on-site in the node the key management and data encryption/data decryption takes place, and what general IT security requirements are placed on the node. Sensitive parts of the procedure must be relocated to hardware-protected environments such as EAL4+ certified hardware tokens according to ISO/IEC-7816, SGX (Software Guard Extensions), TPM (Trusted Platform Module according to TCG specification). The procedure includes a security control system that is used on all nodes and, as far as possible, automatically controls the security on site and reports deviations to the other nodes.

4. Cryptographic Data Chaining System

Another important component is the cryptographic concatenation of data in the file and database systems. The challenge here is not the cryptographically secure concatenation itself, but the economical use of memory. Concatenation prevents memory from being freed, but this happens all the time in file systems and databases. Therefore, special mechanisms must be used that lead to economical use of data storage despite chaining, even in existing file and database systems without modification.

5. Management Blockchain

An important task in today's central IT applications is performed by the so-called authorization systems such as RMS (Microsoft Rights Management System), Active Directory, etc. and the authorization systems integrated in the individual database and operating systems as well as IT applications. In most central IT systems, several authorization systems are active in parallel, and the individual IT applications usually obtain the authorizations and roles of the individual users completely or partially from these systems as needed.

In contrast, the method according to the invention generates the management blockchain in one or more service nodes by fetching the authorizations from the authorization systems and/or by entering the authorizations in full or in part directly in service nodes and immediately writing all changes to the management blockchain. The data itself is thereby subdivided into blocks. Such a block can be, for example, a role with all associated subroles, users, user groups and objects (such as file directories or databases or tables, rows, columns, etc. of databases). After an end-valid chaining of a block, each node can check, based on the management blockchain, whether an authorized person has created and chained this block.

That is, in the method according to the invention, in addition to the data blockchain, where previous data of the central system can be concatenated in each node but, depending on the processing mode, do not have to be, there is another blockchain, the so-called management blockchain, which is necessary, among other things, to combine classical authorization systems and then make them available to all nodes. This management blockchain contains at least four different block types: Blocks with all relevant data about the individual nodes (node blocks), blocks with all authorizations from the authorization systems (authorization blocks), certificate blocks with all required certificates of the nodes (a certificate contains the public key of an asymmetric cryptography and the associated name of the “owner”), parameter blocks with all parameters for key management and for encryption/decryption of the data and for data conversion and for root key calculation.

This management blockchain supplies the individual nodes with the required permissions and other data (such as certificates, parameters, etc.), increases availability, and serves as a logging of the sensitive area of permissions.

6. Synchronization and Replication of all Databases and Files in all Nodes

Today's database systems are often not capable of all nodes being database servers at the same time if desired, but this is required in a decentralized system such as in the present object of the invention, and the required access protection in the completely open nodes cannot be implemented either. This requires suitable replication and synchronization of all databases in all nodes. With database replication and synchronization, data is automatically exchanged between all nodes in such a way that all databases in all nodes have the same information status. The result is a distributed database in all nodes. The same applies to file systems.

### BRIEF DESCRIPTION OF THE DRAWING

In the accompanying figures, the principle of the present invention is shown schematically. It shows:

FIG. 1 the principle of a blockchain;

FIG. 2 a node;

FIG. 3 several nodes in a network; and

FIG. 4 shows the individual modules of the middleware according to the invention as it interacts with a service node.

### BEST WAY TO CARRY OUT THE INVENTION

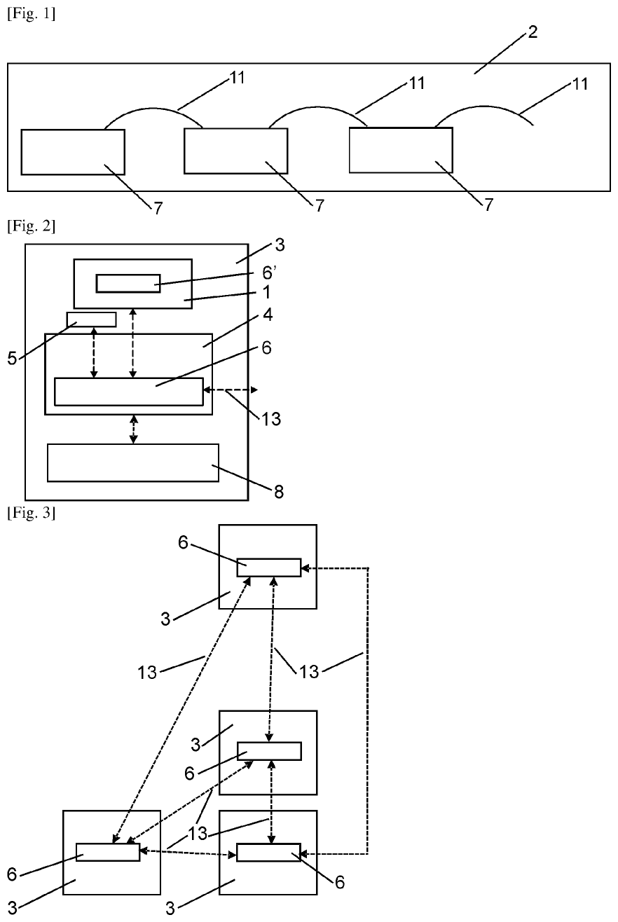

The principle of a blockchain is evident from FIG. 1. In a data blockchain 2, there are blocks 7 that are interconnected by concatenations 11. Each concatenation 11 consists in principle of each block 7 having stored at least one hash value of the previous block 7, so that it is immediately recognizable when one of the previous blocks has been manipulated. Thus, the history of the changes can be fully traced at any time.

In FIG. 2, a node 3 is shown. The Node 3 includes an operating system 4 in which the middleware 6 according to the invention is integrated. The middleware 6 communicates with other nodes via a network 13, as will be explained in more detail with reference to FIG. 3. The middleware 6 also communicates with a database system 5. The node 3 also runs an IT application 1 that may contain a further part 6′ of the middleware. The IT application 1 communicates in the usual way with the operating system 4 (in this case with the middleware 6 of the operating system 4), i.e. it issues read and write commands. The operating system 4 in turn communicates in the usual way with a file system 8 of a nonvolatile memory that is also present in the node 3. The data blockchain 2 (see FIG. 1) is stored in this file system.

FIG. 3 shows the connection of several (in the example four) Nodes 3 that are shown simplified compared to FIG. 2. Via a network 13, each node 3 can communicate with any other node 3.

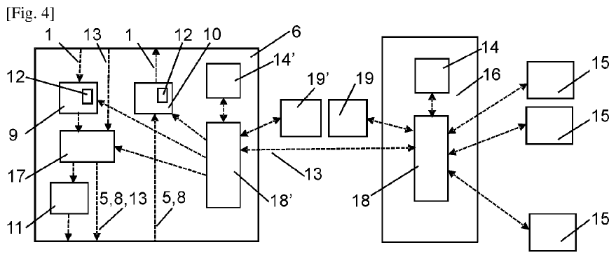

In FIG. 4, the middleware 6 is shown as it communicates with a service node 16. (In fact, of course, in practice there are multiple nodes with middleware 6 and multiple service nodes 16 in the network 13). The service node 16 has a management unit 18. The management unit 18 of the service node 16 manages a management blockchain 14, key management, etc. For this purpose, it is in communication with several (in the example three) central authorization and authorization systems 15 and updates the management blockchain 14 based on changes in these central authorization systems 15. The middleware 6 also has an management unit 18′, whereby these are in communication with the management unit 18 of the service node 16 via the network 13 in order to compare a local copy 14′ of the management blockchain with the management blockchain 14 in the service node 16 and thus obtain the respective current authorizations. In this way, a temporary failure of the central authorization systems 15 has no effect. The management units 18, 18′ are each in communication with a hardware token 19, 19′.

As explained above, a central aspect of the present invention is the encryption 9 of the data and the decryption 10 of the data. This is done with the aid of cryptographic keys 12 provided by the management unit 18′. The encrypted data is transferred from the database system 5 or the file system 8 to the decryption unit 10 and from there in clear text to the application 1 is transmitted. Conversely, data coming in plain text from the application 1 is transmitted for encryption 9 and then fed in encrypted form to the database system 5 or the file system 8 and transmitted to the other nodes for data replication via the network 13. Before this, however, a check is made in the system 17 to verify the write authorization, whether this node is authorized to write this data. If this is the case, then in addition to the appropriate transfer of the data to the database system 5 or the file system 8 and to the network 13, an entry is also made in the data blockchain 2 if the processing mode provides for chaining.

### REFERENCE LIST

1 Applications in own node
2 Blockchain
3 Node
4 Operating-system in own node
5 Database-systems in own node
6 Middleware
7 Block of the blockchain
8 File system and nonvolatile memory in own node
9 Encryption of data
10 Decryption of data
11 Chaining of the blocks
12 Cryptographic keys
13 Network
14, 14′ Management blockchain
15 Central authorization and permission systems
16 Service nodes
17 System for checking write permission
18, 18′ Management unit in nodes
19, 19′ Hardware tokens

1. A method of migrating an IT application of a central system to an IT application with blockchain technology or Distributed Ledger Technology and that runs on several nodes, including all or certain data desired by the respective node, so that the entire processing of the IT application takes place in the nodes including all relevant data, and the nodes exchange the required data via a network, wherein
a program is integrated into the operating system and/or before and/or in and/or after database system and/or IT applications as middleware, so that the IT application does not have to be modified or only slightly modified,
in accordance with the authorizations and thus the relevant read protection and preferably also write protection, the data or parts thereof are cryptographically encrypted before being written to a nonvolatile data memory and/or database system and/or file system and,
after being read from a nonvolatile data memory and/or database system and/or file system, the data or parts thereof are cryptographically decrypted.

2. The method according to claim 1, wherein
the access authorizations to data in database systems and files are stored in a management blockchain accessible to all nodes, created from the data of the authorization systems present in the central system and/or other data from a management unit in service nodes, and
in nodes this management unit is connected in the middleware to the IT applications and/or the operating system and/or the database systems and/or the central authorization systems.

3. The method according to claim 2, wherein the management blockchain contains different block types in the form of node blocks, namely
node blocks with important information about all nodes authorization blocks with all relevant authorizations authorizations, determined from one or more conditions certificate blocks with all necessary certificates and/or
parameter blocks with all necessary values for the key management and/or the data encryption/data decryption and/or the data conversion and/or the root key calculation.

4. The method according to claim 1, wherein for secure traceability of the processing, data required are concatenated by a concatenation to form a data blockchain.

5. The method according to claim 4, wherein data is made unreadable despite the concatenation of the data blocks by deleting the key in all nodes.

6. The method according to claim 1, wherein for the cryptographic encryption and decryption and calculation of electronic signatures only lattice-based and/or code-based and/or hash-based and/or multivariant cryptography and/or cryptography based on supersingular isogenic curves and/or AES algorithm for symmetric cryptography are used.

7. The method according to claim 1, wherein in the encryption of data for database systems, rows and/or columns or data fields of rows of tables supplied to the database in encrypted form are cryptographically encrypted according to the authorizations of users and/or roles and/or other subjects.

8. The method according to claim 7, wherein several individual data fields of rows of tables of databases and/or entire rows/columns of tables that have the same encryption or decryption key are combined into a single data field and this combined data field is encrypted or decrypted, and before this combination of data fields, the individual data fields are converted into a special uniform dense without gaps, data type and, after the encryption or decryption, are converted back into the original data types.

9. The method according to claim 7, wherein during the encryption and decryption of these rows and/or columns or data fields of rows of tables, format-preserving cryptography is used so that the data type and length are preserved and date information remains valid information even after encryption.

10. The method according to claim 1, wherein in each node, all older calculations of the read key are calculated from the current cryptographic read key by asymmetric quantum computer-secure decryption, and new key calculations are calculated in service nodes or hardware tokens as part of the service nodes by asymmetric quantum computer-secure encryption.

11. The method according to claim 1, wherein the cryptographic concatenation of the data blocks is separated into a multistage level and that on the lowest level no concatenation takes place and this only applies to the node and that on the middle level a temporary concatenation takes place and this only applies to the node and that on the upper level with validity in the entire system a final concatenation takes place and that the lowest and/or middle level and/or upper level can also be omitted and that storage can thereby still be released during processing in the node and before distribution to all other nodes and storage space can be saved and that instead of data, of database commands or files only the hash values thereof including header data are concatenated.

12. The method according to characterized claim 1, wherein
in the case of at least one data field, the possible values are divided into classes with a class width of 2n, and
encryption or decryption is carried out as often as necessary until, after the encryption or decryption, the value is again in the predetermined class, so that, even after the encryption, the values of all the individual elements of one class are greater or are smaller than the values of all individual elements of another class, so that the conditions < and > and ≤ and ≥ are thereby maintained despite encryption, and the bit length of the individual elements of an interval is always oriented to the required bit length of the largest value of the interval.

13. The method according to claim 1, wherein the central authorization systems for supplying the current authorizations are retained and/or in that the central systems for processing applications for users are also retained and in this case act as separate nodes and in this case the data encrypted in the nodes are used unencrypted in the central systems and therefore the data are suitably decrypted before being transferred to a central system and suitably encrypted after leaving the central system.

14. The method according to claim 1, wherein
the middleware contains an IT security system and
this IT security system specifies the security requirements and/or cryptographic methods of each individual node, checks them in all nodes and reports deviations to the other nodes.

15. The method according to claim 1, wherein
the calculation and storage of the cryptographic keys and/or the encryption and decryption of the data blocks in the nodes take place either unprotected in the node or in a hardware-protected sandbox in the node or in external hardware tokens, depending on the security level, and,
if required, the IT security system checks the security level in the node and reports any deviations to the other nodes.

16. The method according to claim 1, wherein
keys for symmetric cryptography are derived from root keys by cryptographic or hash methods and n nodes, hereinafter referred to as main nodes, are initially selected for the calculation of a root key with a start value “x”, each of these n main nodes determining its own root key part as a random number, and
a commutative asymmetric encryption method is used for the calculation of a root key and the start value “x” is first encrypted in a main node using this encryption method and its own root key part as the key, then the result is sent step by step to all the other main nodes, and there the respective current result is further encrypted in the individual main nodes using the respective root key part until encryption has taken place in all the main nodes using its own root key part, as a result of which the root key is obtained at the last main node.

17. The method according to claim 16, wherein for the encrypted transmission of the root key to a new node in the system, this new node also determines its own root key-part as a random number and first the start value “x” is encrypted in the new node using this encryption method and its own root key-part as a key, then the result is sent step by step to all main nodes and there in the individual main nodes the respective current result is encrypted again with the respective root key-part until in all main nodes an encryption with the respective own root key-part took place, and finally the result is sent again to the new node and is decrypted there with the own root key-part, whereby the root key results.

18. The method according to claim 16, wherein
in the case of higher security requirements, all these encryptions take place in external high-security hardware tokens of the individual nodes and all root key parts are located exclusively in these external hardware tokens of the nodes, and
the result of the encryption is also electronically signed in the hardware token of each node, the signature is sent to the next node, all hardware tokens of the main nodes and, if applicable, of the new node check this signature before their encryption process and perform the encryption only if the result is positive, so that all encryptions for root key calculation in hardware tokens are thereby guaranteed.

19. The method according to claim 16, wherein for each of these n main nodes substitute nodes are selected and these receive from the main nodes their root key-part encrypted respectively and thereby for each main node at least one substitute node is available and this is used if the main node fails or is not reachable.

20. The method according to claim 1, wherein
the read database commands and/or file commands are checked with respect to the read authorization of the relevant user or role or other relevant subject, and
the write database commands and/or file commands are checked with respect to the write authorization of the relevant user or of the relevant role or of another relevant subject, respectively, are checked by the own node and, in the case of data replication to all other nodes, are checked by the other nodes with the aid of the management unit according to the management blockchain and, if valid, are passed on to the relevant database system or file system, respectively.

21. The method according to claim 20, wherein during data replication at the other nodes, the validity start time of the write authorization is also compared with the time stamp and the plausibility of the time stamp is checked.

22. The method according to claim 20, wherein
the replication of the data from the own node to all other nodes,
the data required for the replication are provided by the own node with an electronic signature and sent to all other nodes and
all other nodes check the signature after receipt and, if the signature is incorrect, reject the data for the data replication from the other nodes.
